(19) United States
(12) Patent Application Publication
(10) Pub. No.: US 2024/0264515 A1
(43) Pub. Date: Aug. 8, 2024

(54) LASER PROJECTION APPARATUS

(71) Applicant: HISENSE LASER DISPLAY CO., LTD, Qingdao (CN)

(72) Inventors: Ke YAN, Qingdao (CN); Youliang TIAN, Qingdao (CN); Wei LI, Qingdao (CN)

(73) Assignee: HISENSE LASER DISPLAY CO., LTD, Qingdao (CN)

(21) Appl. No.: 18/596,190

(22) Filed: Mar. 5, 2024

Related U.S. Application Data
(63) Continuation of application No. PCT/CN2022/113144, filed on Aug. 17, 2022.

(30) Foreign Application Priority Data
Sep. 6, 2021 (CN) 202111037636.X
Sep. 6, 2021 (CN) 202111038612.6
Sep. 23, 2021 (CN) 202111117186.5
Sep. 23, 2021 (CN) 202122306032.2

(51) Int. Cl. G03B 21/20; G03B 33/12

(52) U.S. Cl. CPC G03B 21/2033; G03B 21/2066; G03B 21/2073; G03B 21/208; G03B 33/12

(57) ABSTRACT

A laser projection apparatus includes a laser source assembly, a light modulation assembly, and a projection lens. The laser source assembly includes a laser device, a combining lens group, and a fly-eye lens. The laser device is configured to emit laser beams of three colors. The laser beams of the three colors includes a blue laser beam, a green laser beam, and a red laser beam. The combining lens group is located on a laser-exit side of the laser device and configured to combine the laser beams emitted by the laser device. The fly-eye lens is located on a laser-exit side of the combining lens group and configured to homogenize the laser beams emitted by the laser device.

### CROSS-REFERENCE TO RELATED APPLICATIONS

This application is a continuation application of International Patent Application No. PCT/CN2022/113144, filed on Aug. 17, 2022, which claims priority to Chinese Patent Application No. 202111038612.6, filed on Sep. 6, 2021; Chinese Patent Application No. 202122306032.2, filed on Sep. 23, 2021; Chinese Patent Application No. 202111037636.X, filed on Sep. 6, 2021; and Chinese Patent Application No. 202111117186.5, filed on Sep. 23, 2021, which are incorporated herein by reference in their entireties.

### TECHNICAL FIELD

The present disclosure relates to the field of projection technologies and, in particular, to a laser projection apparatus.

### BACKGROUND

With the development of optoelectronic technologies, people have higher and higher requirements for projection images of laser projection apparatus. In order to improve the display luminance of the projection image, a laser device is usually used to provide illumination beams for the laser projection apparatus. Laser beams emitted by the laser device have advantages of high monochromaticity and high luminance and are an ideal laser source.

### SUMMARY

In an aspect, a laser projection apparatus is provided. The laser projection apparatus includes a laser source assembly, a light modulation assembly, and a projection lens. The laser source assembly is configured to provide illumination beams. The light modulation assembly is configured to modulate the illumination beams provided by the laser source assembly, so as to obtain projection beams. The projection lens is configured to project the projection beams into an image. The laser source assembly includes at least one laser device, a combining lens group, and a fly-eye lens. The at least one laser device is configured to emit laser beams of three colors. The laser beams of three colors include a blue laser beam, a green laser beam, and a red laser beam. The combining lens group is located on a laser-exit side of the at least one laser device and configured to combine the laser beams emitted by the at least one laser device. The fly-eye lens is located on a laser-exit side of the combining lens group and configured to homogenize the laser beams emitted by the at least one laser device. The fly-eye lens includes a base, a plurality of first microlenses, and a plurality of second microlenses. The plurality of first microlenses are disposed on a laser-incident surface of the base. The plurality of first microlenses include a plurality of first sub-microlenses and a plurality of second sub-microlenses. The plurality of first sub-microlenses are configured to receive the blue laser beam, the green laser beam, and a first portion of the red laser beam. The plurality of second sub-microlenses are configured to receive a second portion of the red laser beam. The plurality of second microlenses are disposed on a laser-exit surface of the base and respectively correspond to the plurality of first microlenses. An area of a beam spot produced by the blue laser beam and the green laser beam on a laser-incident surface of the fly-eye lens is less than an area of a beam spot produced by the red laser beam on the laser-incident surface of the fly-eye lens. A dimension of the first sub-microlens in a fast axis direction of the incident laser beam is greater than a dimension of the second sub-microlens in the fast axis direction.

In another aspect, a laser projection apparatus is provided. The laser projection apparatus includes a laser source assembly, a light modulation assembly, and a projection lens. The laser source assembly is configured to provide illumination beams. The laser source assembly includes at least one laser device, a combining lens group, a fly-eye lens, and a diffusion plate. The at least one laser device is configured to emit laser beams of three colors. The laser beams of three colors include a blue laser beam, a green laser beam, and a red laser beam. The combining lens group is located on a laser-exit side of the at least one laser device and configured to combine the laser beams emitted by the at least one laser device. The fly-eye lens is located on a laser-exit side of the combining lens group and configured to homogenize the laser beams emitted by the at least one laser device. The diffusion plate is located between the combining lens group and the fly-eye lens and configured to homogenize the incident laser beams. The light modulation assembly is configured to modulate the illumination beams provided by the laser source assembly, so as to obtain projection beams. The light modulation assembly includes a lens group, a prism group, and a light modulation device. The lens group is located on a laser-exit side of the fly-eye lens. A center point of a laser-exit surface of the fly-eye lens coincides with a focus of the lens group, and the lens group is configured to first diffuse the illumination beams and then converge the illumination beams. The prism group is located on a laser-exit side of the lens group and configured to reflect the illumination beams to the light modulation device. The light modulation device is configured to modulate the illumination beams, so as to obtain the projection beams. The projection lens is configured to project the projection beams into an image.

### BRIEF DESCRIPTION OF THE DRAWINGS

FIG. 1 is a diagram showing a structure of a laser projection apparatus, in accordance with some embodiments;

FIG. 2 is a diagram showing a structure of a laser projection apparatus and a projection screen, in accordance with some embodiments;

FIG. 3 is a diagram showing a beam path of a laser source assembly, a light modulation assembly, and a projection lens in a laser projection apparatus, in accordance with some embodiments;

FIG. 4 is a diagram showing another beam path of a laser source assembly, a light modulation assembly, and a projection lens in a laser projection apparatus, in accordance with some embodiments;

FIG. 5 is a diagram showing an arrangement of micromirrors in a digital micromirror device, in accordance with some embodiments;

FIG. 6 is a schematic diagram showing operation of micromirrors, in accordance with some embodiments;

FIG. 7 is a diagram showing a structure of a laser source assembly in the related art;

FIG. 8 is a diagram showing a structure of another laser source assembly in the related art;

FIG. 9A is a diagram showing a structure of a laser source assembly and a light modulation assembly in a laser projection apparatus, in accordance with some embodiments;

FIG. 9B is a diagram showing another structure of a laser source assembly and a light modulation assembly in a laser projection apparatus, in accordance with some embodiments;

FIG. 9C is a diagram showing yet another structure of a laser source assembly and a light modulation assembly in a laser projection apparatus, in accordance with some embodiments;

FIG. 9D is a diagram showing yet another structure of a laser source assembly and a light modulation assembly in a laser projection apparatus, in accordance with some embodiments;

FIG. 10 is a diagram showing a structure of a first combining component, in accordance with some embodiments;

FIG. 11 is a diagram showing a beam path of a fly-eye lens and a light modulation assembly, in accordance with some embodiments;

FIG. 12A is a diagram showing yet another structure of a laser source assembly and a light modulation assembly in a laser projection apparatus, in accordance with some embodiments;

FIG. 12B is a diagram showing a structure of another laser projection apparatus, in accordance with some embodiments;

FIG. 13 is a diagram showing yet another structure of a laser source assembly and a light modulation assembly in a laser projection apparatus, in accordance with some embodiments;

FIG. 14A is a diagram showing yet another structure of a laser source assembly and a light modulation assembly in a laser projection apparatus, in accordance with some embodiments;

FIG. 14B is a diagram showing yet another structure of a laser source assembly and a light modulation assembly in a laser projection apparatus, in accordance with some embodiments;

FIG. 15 is a diagram showing a beam path of a fly-eye lens, in accordance with some embodiments;

FIG. 16 is a front view of a fly-eye lens, in accordance with some embodiments;

FIG. 17A is a schematic diagram of beam spots formed by the laser devices shown in FIGS. 9A and 9B;

FIG. 17B is a schematic diagram of beam spots formed by the laser device shown in FIG. 14B on a fly-eye lens;

FIG. 17C is a schematic diagram of beam spots formed by the laser devices shown in FIG. 9C on a fly-eye lens;

FIG. 17D is a schematic diagram of beam spots formed by the laser devices shown in FIG. 9D on a fly-eye lens;

FIG. 18 is a front view of the fly-eye lens shown in FIG. 14B; and

FIG. 19 is a diagram showing another beam path of a fly-eye lens, in accordance with some embodiments.

### DETAILED DESCRIPTION

Some embodiments of the present disclosure will be clearly and completely described below with reference to the accompanying drawings. However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to.” In the description of the specification, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only and are not to be construed as indicating or implying the relative importance or implicitly indicating the number of indicated technical features. Thus, features defined by “first” or “second” may explicitly or implicitly include one or more of the features. In the description of the embodiments of the present disclosure, the term “a plurality of” or “the plurality of” means two or more unless otherwise specified.

In the description of some embodiments, the term “connected,” and derivative thereof may be used. The term “connected” should be understood in a broad sense. For example, the term “connected” may represent a fixed connection, a detachable connection, or a one-piece connection, or may represent a direct connection, or may represent an indirect connection through an intermediate medium. The embodiments disclosed herein are not necessarily limited to the content herein.

The phrase “at least one of A, B, and C” has the same meaning as the phrase “at least one of A, B, or C,” both including the following combinations of A, B, and C: only A, only B, only C, a combination of A and B, a combination of A and C, a combination of B and C, and a combination of A, B, and C.

The use of the phase “applicable to” or “configured to” herein means an open and inclusive expression, which does not exclude devices that are applicable to or configured to perform additional tasks or steps.

The term such as “about,” “substantially,” and “approximately” as used herein includes a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

The term such as “parallel,” “perpendicular,” or “equal” as used herein includes a stated condition and a condition similar to the stated condition. A range of the similar condition is within an acceptable deviation range, and the acceptable deviation range is determined by a person of ordinary skill in the art, considering measurement in question and errors associated with measurement of a particular quantity (i.e., the limitations of a measurement system).

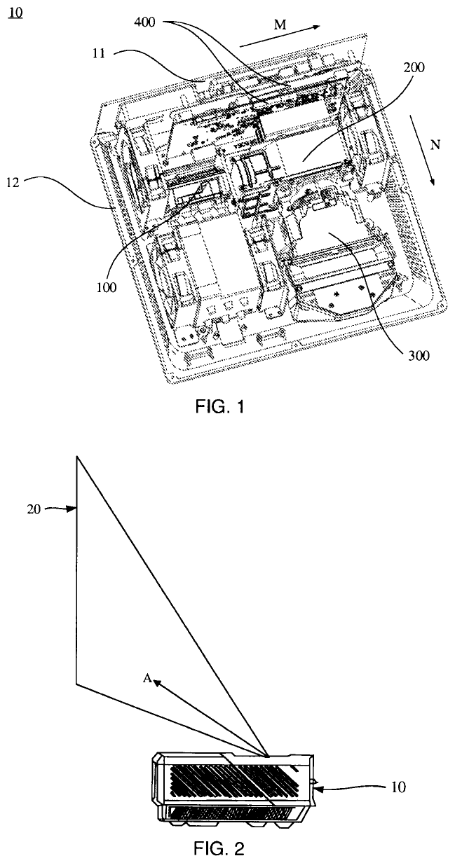

In some embodiments of the present disclosure, a laser projection apparatus is provided. As shown in FIG. 1, the laser projection apparatus 10 includes a housing 11 (only a portion of the housing 11 being shown in FIG. 1) and a bottom seat 12. The housing 11 and the bottom seat 12 form an accommodating space. The laser projection apparatus 10 further includes a laser source assembly 100, a light modulation assembly 200, and a projection lens 300 that are located in the accommodating space and assembled on the bottom seat 12. The laser source assembly 100 is configured to provide illumination beams (e.g., laser beams). The light modulation assembly 200 is configured to modulate the illumination beams provided by the laser source assembly 100 with image signals, so as to obtain projection beams. The projection lens 300 is configured to project the projection beams into an image on a projection screen 20 or a wall.

For example, as shown in FIG. 2, the projection beams are incident on the projection screen 20 in an oblique upward direction (e.g., the direction A) after entering the projection lens 300. Such projection arrangement has a lower projection ratio (i.e., a ratio of a distance between the laser projection apparatus 10 and the projection screen 20 to a dimension of a diagonal of the projection image), and the distance between the laser projection apparatus 10 and the projection screen 20 is reduced, so that a large-sized projection image may be displayed with a lower projection ratio.

As shown in FIG. 1, a first end of the light modulation assembly 200 is connected to the laser source assembly 100, and the laser source assembly 100 and the light modulation assembly 200 are arranged in an exit direction (referring to the direction M shown in FIG. 1) of the illumination beams of the laser projection apparatus 10. A second end of the light modulation assembly 200 is connected to the projection lens 300, and the light modulation assembly 200 and the projection lens 300 are arranged in an exit direction (referring to the direction N shown in FIG. 1) of the projection beams of the laser projection apparatus 10. The direction M is substantially perpendicular to the direction N. In one aspect, such connection structure may adapt to characteristics of a beam path of a reflective light valve in the light modulation assembly 200, and in another aspect, it is also conducive to shortening a length of a beam path in a one-dimensional direction, which is helpful for structural arrangement of the laser projection apparatus 10. For example, in a case where the laser source assembly 100, the light modulation assembly 200, and the projection lens 300 are disposed in a one-dimensional direction (e.g., the direction M), the length of the beam path in the one-dimensional direction is long, which is not conducive to the structural arrangement of the laser projection apparatus 10. The reflective light valve will be described below.

In some embodiments, the laser source assembly 100 may sequentially provide beams of three primary colors (beams of other colors may also be added on a basis of the beams of the three primary colors). Due to a phenomenon of visual perception of human eyes, what the human eyes see is white beams formed by mixing the beams of three primary colors. Alternatively, the laser source assembly 100 may also simultaneously output the beams of three primary colors, so as to continuously emit the white beams. The laser source assembly 100 may include a laser device that may emit a laser beam of at least one color, such as a red laser beam, a blue laser beam, or a green laser beam.

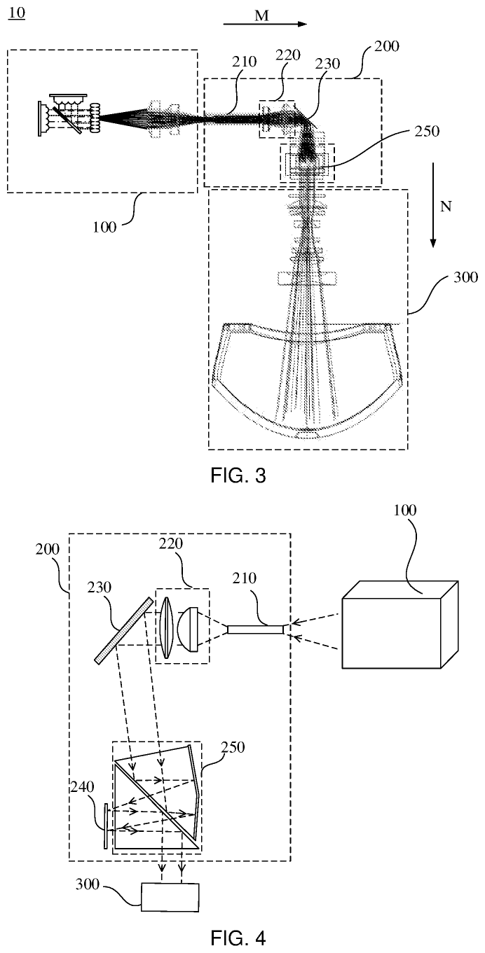

The illumination beams emitted by the laser source assembly 100 enter the light modulation assembly 200. Referring to FIGS. 3 and 4, the light modulation assembly 200 includes a light pipe 210, a lens group 220, a reflector 230, a light modulation device 240, and a prism group 250. The light pipe 210 is located on a laser-exit side of the laser source assembly 100 and configured to receive the illumination beams provided by the laser source assembly 100 and homogenize the illumination beams. The lens group 220 is located on a laser-exit side of the light pipe 210 and configured to first diffuse the illumination beams, and then converge the illumination beams and propagate the illumination beams to the reflector 230. The reflector 230 is located on a laser-exit side of the lens group 220 and configured to reflect the illumination beams to the prism group 250. The prism group 250 is located on a laser-exit side of the reflector 230 and configured to reflect the illumination beams to the light modulation device 240. The prism assembly 250 may include a total internal reflection (TIR) prism. The light modulation device 240 may include a digital micromirror device (DMD) and be configured to modulate the illumination beams to obtain the projection beams and reflect the obtained projection beams after modulation to the projection lens 300. It may be understood that the light pipe 210 may also be disposed in the laser source assembly 100.

In the light modulation assembly 200, the DMD is configured to use an image signal to modulate the illumination beams provided by the laser source assembly 100. That is to say, the DMD controls the projection beams to display different luminance and gray scales according to different pixels in an image to be displayed, so as to finally produce a projection image. Therefore, the DMD is also referred to as a light valve. In addition, the light modulation assembly 200 may be classified as a single-chip system, a double-chip system, or a three-chip system according to the number of the light modulation devices (or the light valves) 240 used in the light modulation assembly 200.

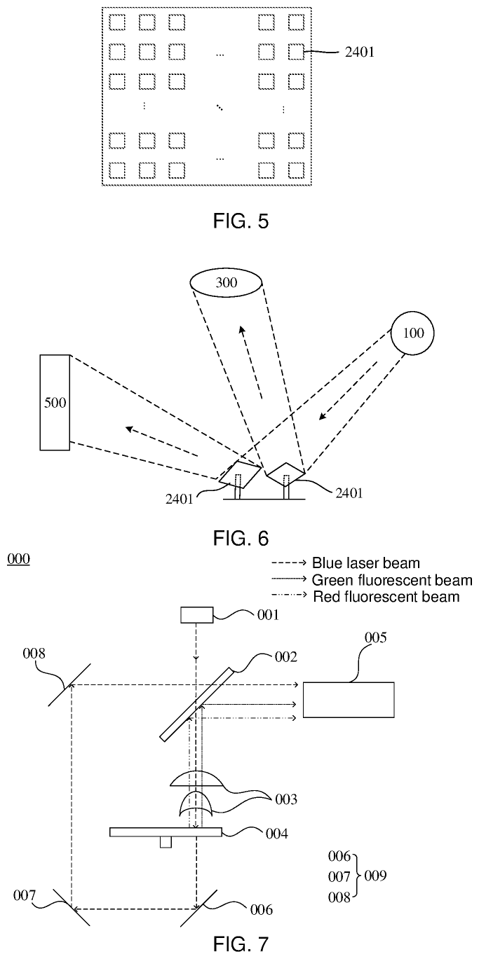

As shown in FIG. 5, the digital micromirror device includes thousands of micromirrors 2401 that may be individually driven to rotate. These micromirrors 2401 are arranged in an array. One micromirror 2401 (e.g., each micromirror 2401) corresponds to one pixel in the image to be displayed. In a digital light processing (DLP) projection architecture, each micromirror 2401 is equivalent to a digital switch. The micromirror 2401 may swing within a range of plus 12° to minus 12° (i.e., ±12°) or a range of plus 17° to minus 17° (i.e., ±17°) due to an action of an external force.

As shown in FIG. 6, a laser beam reflected by the micromirror 2401 at a negative deflection angle is referred to as an OFF laser beam. The OFF laser beam is an ineffective laser beam, which usually irradiates on the housing 11 of the laser projection apparatus 10 or the housing of the light modulation assembly 200, or is absorbed by a light absorption portion 500. A laser beam reflected by the micromirror 2401 at a positive deflection angle is referred to as an ON laser beam. The ON laser beam is an effective laser beam reflected by the micromirror 2401 on a surface of the DMD when the micromirror 2401 receives irradiation of the illumination beams and is used for projecting into an image. An ON state of the micromirror 2401 is a state that the micromirror 2401 is in and may be maintained when the illumination beams emitted by the laser source assembly 100 may enter the projection lens 300 after being reflected by the micromirror 2401. An OFF state of the micromirror 2401 is a state that the micromirror 2401 is in and may be maintained when the illumination beams emitted by the laser source assembly 100 do not enter the projection lens 300 after being reflected by the micromirror 2401.

In a display cycle of a frame of image, some or all of the micromirrors 2401 are switched once between the ON state and the OFF state, so that gray scales of pixels in a frame of an image are achieved according to durations of the micromirrors 2401 in the ON state and the OFF state. For example, in a case where the pixels have 256 gray scales from 0 to 255, micromirrors 2401 corresponding to a gray scale 0 are each in the OFF state in an entire display cycle of a frame of an image, micromirrors 2401 corresponding to a gray scale 255 are each in the ON state in the entire display cycle of a frame of an image, and micromirrors 2401 corresponding to a gray scale 127 are each in the ON state for half of time and in the OFF state for another half of time in the display cycle of a frame of an image. Therefore, by controlling a state that each micromirror 2401 in the DMD is in and a duration of each state in the display cycle of a frame of an image through the image signals, luminance (the gray scale) of a pixel corresponding to the micromirror 2401 may be controlled, thereby modulating the illumination beams projected onto the DMD.

It will be noted that, according to different projection architectures, the light modulation device 240 may be of many kinds, such as a liquid crystal on silicon (LCOS) or the digital micromirror device. Since the light modulation assembly 200 shown in FIG. 4 applies the DLP projection architecture in some embodiments of the present disclosure, the light modulation device 240 in some embodiments of the present disclosure includes the digital micromirror device.

As shown in FIG. 3, the projection lens 300 includes a combination of a plurality of lenses, which are usually divided by groups, and are divided into a three-segment combination including a front group, a middle group, and a rear group, or a two-segment combination including a front group and a rear group. The front group is a lens group proximate to a laser-exit side (i.e., a side of the projection lens 300 away from the light modulation assembly 200 in the direction N in FIG. 3) of the laser projection apparatus 10, and the rear group is a lens group proximate to a laser-exit side (i.e., a side of the projection lens 300 proximate to the light modulation assembly 200 in the opposite direction of the direction N in FIG. 3) of the light modulation assembly 200. The projection lens 300 may include a zoom projection lens, or a prime focus-adjustable projection lens, or a prime projection lens.

As shown in FIG. 1, the laser projection apparatus 10 further includes a plurality of circuit boards 400, and the plurality of circuit boards 400 include a power supply board (i.e., a power board), a signal transmission board (i.e., a TV board), and a display board. The power supply board is configured to supply power to the laser source assembly 100, the DMD, and other circuit boards. The signal transmission board is configured to decode video signals and transmit the decoded image signals to the display board. The display board is configured to process the image signals to generate DMD signals, laser source timing signals, and pulse width modulation (PWM) signals used to adjust luminance, so as to control the imaging of the laser projection apparatus 10.

In some related arts, as shown in FIG. 7, a laser source assembly 000 includes a laser device 001, a dichroic mirror 002, a converging lens group 003, a phosphor wheel 004, a light pipe 005, and a relay loop 009. The relay loop 009 includes a first reflecting lens 006, a second reflecting lens 007, and a third reflecting lens 008. The laser device 001 is configured to emit a laser beam of one color. The phosphor wheel 004 includes a fluorescence region and a transmitting region. The fluorescence region is configured to emit a fluorescent beam due to irradiation of the laser beam and reflect the fluorescent beam. The transmitting region is configured to transmit the laser beam. The dichroic mirror 002 is configured to transmit the laser beam and reflect the fluorescent beam.

The laser beam emitted by the laser device 001 is incident on the phosphor wheel 004 after being transmitted by the dichroic mirror 002 and converged by the converging lens group 003. As the phosphor wheel 004 rotates, when the laser beam emitted by the laser device 001 is incident on the fluorescence region of the phosphor wheel 004, the laser beam may excite the fluorescent material in the fluorescence region to emit the fluorescent beam. The fluorescent beam is reflected by the phosphor wheel 004 to the dichroic mirror 002, and then reflected by the dichroic mirror 002 to the light pipe 005. When the laser beam emitted by the laser device 001 is incident on the transmitting region of the phosphor wheel 004, the laser beam may be transmitted by the transmitting region and incident on the first reflecting lens 006. Then, the laser beam is sequentially reflected by the first reflecting lens 006, the second reflecting lens 007, and the third reflecting lens 008 to the dichroic mirror 002 and transmitted to the light pipe 005 by the dichroic mirror 002.

However, in the laser source assembly 000 shown in FIG. 7, the laser source assembly 000 has a lot of lenses and needs to occupy a large space due to the arrangement of the relay loop 009, resulting in a large volume of the laser source assembly 000.

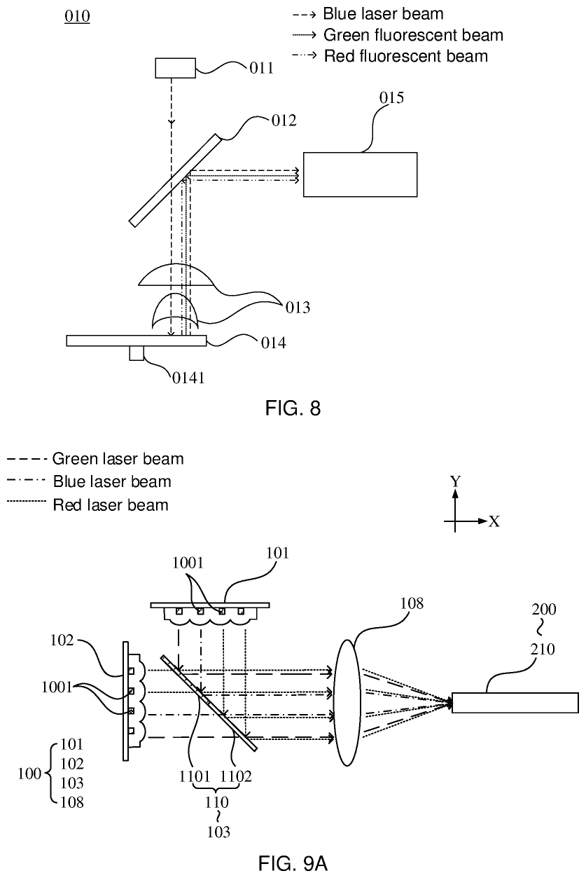

In some other related arts, as shown in FIG. 8, a laser source assembly 010 includes a laser device 011, a combining component 012, a converging lens group 013, a phosphor wheel 014, and a light pipe 015. The laser device 011 is configured to emit a laser beam of one color. The phosphor wheel 014 includes a fluorescence region and a reflecting region. The fluorescence region is configured to emit a fluorescent beam due to irradiation of the laser beam and reflect the fluorescent beam, and the reflecting region is configured to reflect the laser beam. The combining component 012 includes a transmitting portion and a reflecting portion. The transmitting portion is configured to transmit the laser beam emitted by the laser device 011, and the reflecting portion is configured to reflect the fluorescent beam emitted by the excited fluorescence region of the phosphor wheel 014 and the laser beam reflected by the reflecting region of the phosphor wheel 014.

The laser beam emitted by the laser device 011 is incident on the phosphor wheel 014 after being transmitted by the transmitting portion of the combining component 012 and converged by the converging lens group 013. As the phosphor wheel 014 rotates, when the laser beam emitted by the laser device 011 is incident on the fluorescence region of the phosphor wheel 014, the laser beam may excite the fluorescent material in the fluorescence region to emit the fluorescent beam. The fluorescent beam is reflected to the reflecting portion of the combining component 012 by the phosphor wheel 014, and then reflected to the light pipe 015 by the reflecting portion of the combining component 012. When the laser beam emitted by the laser device 011 is incident on the reflecting region of the phosphor wheel 014, the laser beam is reflected to the reflecting portion of the combining component 012 by the reflecting region, and then reflected to the light pipe 015 by the reflection portion of the combining component 012.

Although the above solution can avoid providing the relay loop 009 and reduce the number of lenses in the laser source assembly, the above solution still has the following problems: in order to rotate the phosphor wheel, it is necessary to provide a driving circuit of the phosphor wheel and a driving portion 0141 of the phosphor wheel in the laser source assembly. These components have a large volume and occupy a lot of space in the laser source assembly, which is not conducive to the miniaturization of a laser projection apparatus.

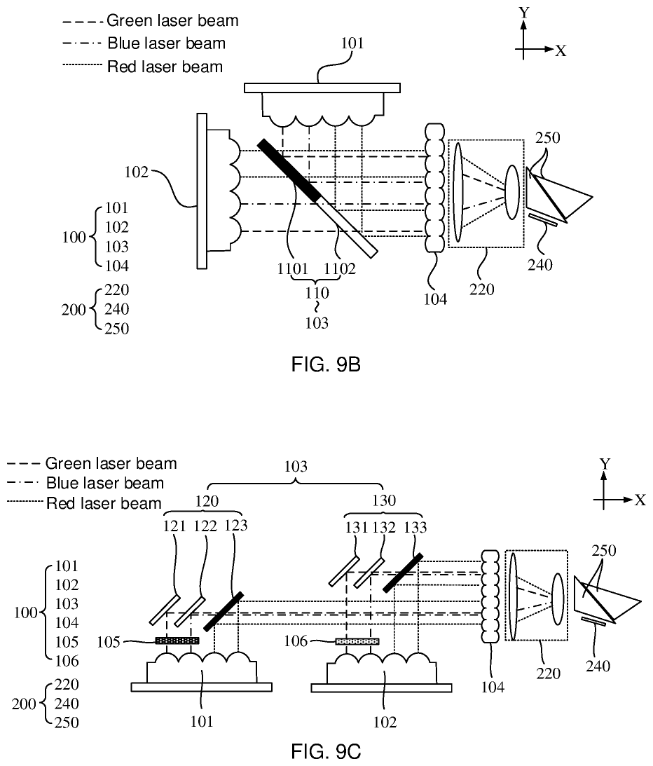

In view of this, the laser source assembly 100 is provided in some embodiments of the present disclosure. As shown in FIGS. 9A and 9B, the laser source assembly 100 includes a first laser device 101, a second laser device 102, and a combining lens group 103. The laser source assembly 100 is configured to emit laser beams of three colors, such as a red laser beam, a blue laser beam, and a green laser beam. The first laser device 101 is configured to emit a first laser beam to the combining lens group 103, and the second laser device 102 is configured to emit a second laser beam to the combining lens group 103. The combining lens group 103 is configured to combine at least one of the first laser beam or the second laser beam and guide the first laser beam and the second laser beam to the light modulation assembly 200.

In some embodiments, the first laser device 101 and the second laser device 102 each are configured to emit laser beams of at least one color, and the first laser device 101 and the second laser device 102 each include a plurality of light-emitting chips 1001 (as shown in FIG. 9A) arranged in an array. For example, the plurality of light-emitting chips 1001 include a red light-emitting chip, a green light-emitting chip, and a blue light-emitting chip, so as to emit laser beams of three colors: red, green, and blue. Here, the red light-emitting chip is a light-emitting chip emitting a red laser beam, the green light-emitting chip is a light-emitting chip emitting a green laser beam, and the blue light-emitting chip is a light-emitting chip emitting a blue laser beam.

It will be noted that some embodiments of the present disclosure are described by considering an example in which the first laser device 101 and the second laser device 102 simultaneously emit laser beams of three colors: blue, green, and red. Of course, the first laser device 101 and the second laser device 102 may also simultaneously emit laser beams of two colors such as a blue laser beam and a yellow laser beam. Alternatively, the first laser device 101 and the second laser device 102 may also emit laser beams of three colors: blue, green, and red, in a time-division manner. It will be noted that the time-division manner refers to different moments.

In some embodiments, structures of the first laser device 101 and the second laser device 102 may be the same or different.

For example, as shown in FIGS. 9A, 9B, and 9C, the first laser device 101 and the second laser device 102 have a same structure. The first laser device 101 and the second laser device 102 each include a plurality of light-emitting chips 1001 arranged in four rows. The plurality of light-emitting chips 1001 include two rows of red light-emitting chips, one row of green light-emitting chips, and one row of blue light-emitting chips. In this way, the first laser device 101 and the second laser device 102 may simultaneously emit red laser beams, green laser beams, and blue laser beams by means of the red light-emitting chips, the green light-emitting chips, and the blue light-emitting chips.

For another example, as shown in FIG. 9D, the first laser device 101 and the second laser device 102 have different structures. The first laser device 101 includes a plurality of light-emitting chips 1001 arranged in four rows. The plurality of light-emitting chips 1001 includes two rows of red light-emitting chips, one row of green light-emitting chips, and one row of blue light-emitting chips. The second laser device 102 includes a plurality of red light-emitting chips arranged in two rows.

In some embodiments, as shown in FIGS. 9A and 9B, a laser-exit direction (e.g., an opposite direction of a second direction Y) of the first laser device 101 is perpendicular to a laser-exit direction (e.g., a first direction X) of the second laser device 102, the combining lens group 103 includes a first combining component 110 located on laser-exit sides of the first laser device 101 and the second laser device 102. An arrangement direction of the first laser device 101 and the first combining component 110 is perpendicular to an arrangement direction of the second laser device 102 and the first combining component 110.

In this case, the first laser beam emitted by the first laser device 101 and the second laser beam emitted by the second laser device 102 are incident on the first combining component 110, and the first combining component 110 is configured to reflect the first laser beam and transmit the second laser beam.

It will be noted that some embodiments of the present disclosure are described by considering an example in which the first direction Y is perpendicular to the second direction X. However, the present disclosure is not limited thereto. For example, an angle between the first direction X and the second direction Y may also be an obtuse angle or an acute angle.

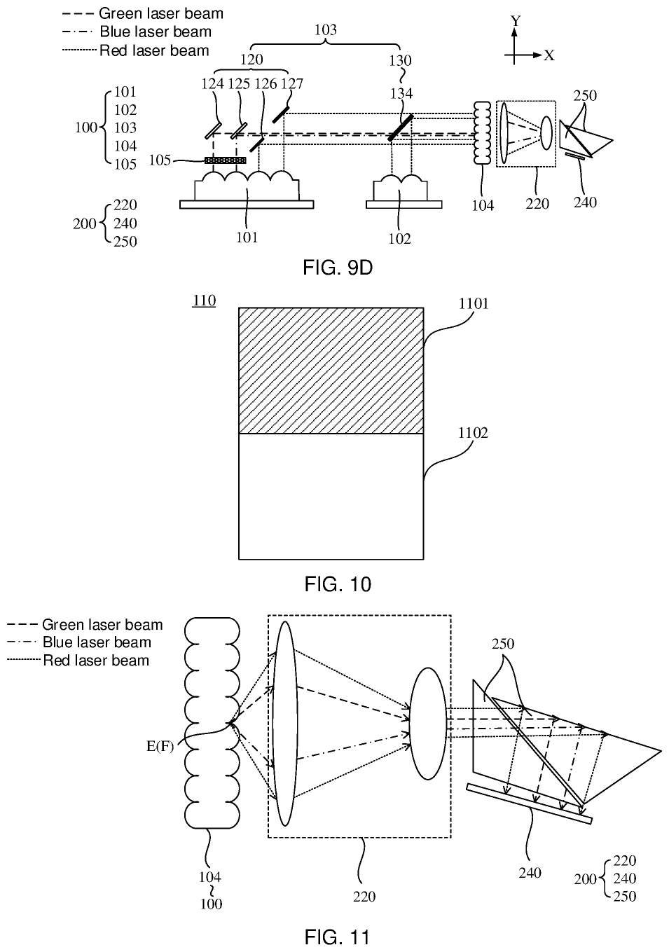

In some embodiments, as shown in FIGS. 9A, 9B and 10, the first combining component 110 includes a first transflective portion 1101 and a second transflective portion 1102. The first transflective portion 1101 and the second transflective portion 1102 are disposed obliquely with respect to the laser-exit direction of at least one of the first laser device 101 or the second laser device 102 and located at an intersection of the laser beams emitted by the first laser device 101 and the second laser device 102. On a plane perpendicular to the laser-exit direction of the first laser device 101 or the second laser device 102, an orthogonal projection of the first transflective portion 1101 is separated from an orthogonal projection of the second transflective portion 1102. That is to say, the orthogonal projection of the first transflective portion 1101 does not overlap with the orthogonal projection of the second transflective portion 1102.

In this case, the first laser device 101 emits the first laser beam to the first transflective portion 1101 and the second transflective portion 1102, and the second laser device 102 emits the second laser beam to the first transflective portion 1101 and the second transflective portion 1102.

For example, in a case where the first laser beam and the second laser beam each include laser beams of three colors, such as the blue laser beam, the green laser beam, and the red laser beam, the first laser device 101 emits the blue laser beam and the green laser beam to the first transflective portion 1101 and the red laser beam to the second transflective portion 1102. The second laser device 102 emits the red laser beam to the first transflective portion 1101 and the blue laser beam and the green laser beam to the second transflective portion 1102.

The first transflective portion 1101 is configured to reflect the blue laser beam and the green laser beam emitted by the first laser device 101 and transmit the red laser beam emitted by the second laser device 102. The second transflective portion 1102 is configured to reflect the red laser beam emitted by the first laser device 101 and transmit the blue laser beam and the green laser beam emitted by the second laser device 102.

In some embodiments, the first transflective portion 1101 and the second transflective portion 1102 are two dichroic elements with different wavelength selection characteristics. For example, the first transflective portion 1101 is a dichroic mirror reflecting the blue laser beam and the green laser beam and transmitting laser beams of other colors, and the second transflective portion 1102 is a dichroic mirror reflecting the red laser beam and transmitting laser beams of other colors.

In this way, the laser beams emitted by the first laser device 101 and the second laser device 102 may be combined by one first combining component 110 with different wavelength selection characteristics, the beam path is compact, which is conducive to the miniaturization of the laser projection apparatus 10. Moreover, the dichroic element has high transmissivity and reflectivity, which may improve the laser-exit efficiency of the laser source assembly 100. It will be noted that combining the laser beams refers to adjusting multiple laser beams to a substantially same beam path.

In some other embodiments, the first transflective portion 1101 and the second transflective portion 1102 may be two polarizing elements with different polarization direction selection characteristics.

For example, the first laser device 101 and the second laser device 102 each emit laser beams of three colors (e.g., the blue laser beam, the green laser beam, and the red laser beam), the blue laser beam and the green laser beam are first polarized light, and the red laser beam is second polarized light, and a polarization direction of the first polarized light is substantially perpendicular to a polarization direction of the second polarized light. Here, the first polarized light may be S-polarized light, and the second first polarized light may be P-polarized light.

In this case, the first transflective portion 1101 may be a polarizing sheet reflecting the first polarized light (i.e., the blue laser beam and the green laser beam) and transmitting the second polarized light (i.e., the red laser beam). The second transflective portion 1102 may be a polarizing sheet reflecting the second polarized light and transmitting the first polarized light. In this way, the laser beams emitted by the first laser device 101 and the second laser device 102 may be combined by one first combining component 110 with different polarization direction selection characteristics, and the beam path is compact, which is conducive to the miniaturization of the laser projection apparatus 10.

Of course, the first combining component 110 may also be a one-piece member. For example, the first combining component 110 includes a transparent substrate, and the first transflective portion 1101 and the second transflective portion 1102 may be formed on the transparent substrate by means of coating films. The coating films may be coating films with different wavelength or polarization direction selection characteristics.

In some other embodiments, as shown in FIGS. 9C and 9D, a laser-exit direction (i.e., the second direction Y) of the first laser device 101 is parallel to a laser-exit direction (i.e., the second direction Y) of the second laser device 102, and the combining lens group 103 includes a second combining component 120 and a third combining component 130. The second combining component 120 is located on a laser-exit side of the first laser device 101, and the third combining component 130 is located on a laser-exit side of the second laser device 102. An arrangement direction of the first laser device 101 and the second combining component 120 is parallel to an arrangement direction of the second laser device 102 and the third combining component 130.

In some embodiments, the first laser device 101 emits a first laser beam to the second combining component 120, and the second laser device 102 emits a second laser beam to the third combining component 130. The second combining component 120 is configured to reflect the first laser beam to a fly-eye lens 104 (as shown in FIGS. 9C and 9D), and the third combining component 130 is configured to reflect the second laser beam to the fly-eye lens 104. Here, the laser source assembly 100 further includes the fly-eye lens 104 located on a laser-exit side of the combining lens group 103 and configured to homogenize the laser beams emitted by the at least one laser device.

In some embodiments, as shown in FIG. 9C, in a case where the first laser beam and the second laser beam each include laser beams of three colors, such as the green laser beam, the blue laser beam, and the red laser beam, the second combining component 120 and the third combining component 130 have a same structure, and on a plane where a laser-incident surface of the fly-eye lens 104 is located, an orthogonal projection of the second combining component 120 is separated from an orthogonal projection of the third combining component 130.

Here, the plane where the laser-incident surface of the fly-eye lens 104 is located may also be understood as a plane perpendicular to the first direction X, or a plane perpendicular to the laser-exit directions of the second combining component 120 and the third combining component 130.

The second combining component 120 includes a first lens 121, a second lens 122, and a third lens 123. The first lens 121, the second lens 122, and the third lens 123 are sequentially arranged in the first direction X, and each is obliquely disposed with respect to the first direction X. On the plane where the laser-incident surface of the fly-eye lens 104 is located, an orthogonal projection of the first lens 121, an orthogonal projection of the second lens 122, and an orthogonal projection of the third lens 123 at least partially overlap with each other.

The first laser device 101 emits the green laser beam to the first lens 121, the blue laser beam to the second lens 122, and the red laser beam to the third lens 123. The first lens 121 is located on a laser-exit path of the green laser beam emitted by the first laser device 101 and configured to reflect the green laser beam. The second lens 122 is located on a laser-exit path of the blue laser beam emitted by the first laser device 101 and configured to reflect the blue laser beam and transmit the green laser beam. The third lens 123 is located on a laser-exit path of the red laser beam emitted by the first laser device 101 and configured to reflect the red laser beam and transmit the green laser beam and the blue laser beam.

In some embodiments, the first lens 121 may be a mirror for reflecting laser beams of all colors or may be a dichroic mirror for reflecting the green laser beam and transmitting laser beams of other colors. The second lens 122 may be a dichroic mirror for reflecting the blue laser beam and transmitting laser beams of other colors. The third lens 123 may be a dichroic mirror for reflecting the red laser beam and transmitting laser beams of other colors.

The third combining component 130 includes a first lens 131, a second lens 132, and a third lens 133. Structures and functions of the first lens 131, the second lens 132, and the third lens 133 of the third combining component 130 are similar to that of the first lens 121, the second lens 122, and the third lens 123 of the second combining component 120, respectively, and details will not be repeated herein. Here, since the structures and functions of the third combining component 130 are similar to that of the second combining component 120, the lenses of the third combining component 130 and the second combining component 120 share a same name and are distinguished by different reference signs.

It will be noted that, as shown in FIG. 9C, on the plane where the laser-incident surface of the fly-eye lens 104 is located, the orthogonal projection of the second combining component 120 is separated from the orthogonal projection of the third combining component 130, so as to prevent the lenses of the third combining component 130 from blocking the laser beams emitted by the second combining component 120.

In some other embodiments, as shown in FIG. 9D, in a case where the first laser beam includes laser beams of three colors (e.g., the green laser beam, the blue laser beam, and the red laser beam), and the second laser beam includes a laser beam of one color (e.g., the red laser beam), the second combining component 120 includes a fourth lens 124, a fifth lens 125, a sixth lens 126, and a seventh lens 127, and the third combining component 130 includes an eighth lens 134.

On the plane where the laser-incident surface of the fly-eye lens 104 is located, an orthogonal projection of the fourth lens 124 at least partially overlaps with an orthogonal projection of the fifth lens 125, orthogonal projections of the sixth lens 126 and the seventh lens 127 are located on two sides of the orthogonal projection of the fifth lens 125 in the second direction Y, respectively, and an orthogonal projection of the eighth lens 134 at least partially overlaps with the orthogonal projections of the fourth lens 124 and the fifth lens 125 and is separated from the orthogonal projections of the sixth lens 126 and the seventh lens 127. For example, on the plane where the laser-incident surface of the fly-eye lens 104 is located, the orthogonal projection of the fourth lens 124 may substantially coincide with the orthogonal projection of the fifth lens 125.

The first laser device 101 emits the green laser beam to the fourth lens 124, the blue laser beam to the fifth lens 125, and the red laser beam to the sixth lens 126 and the seventh lens 127. The fourth lens 124 is located on a laser-exit path of the green laser beam emitted by the first laser device 101 and configured to reflect the green laser beam. The fifth lens 125 is located on a laser-exit path of the blue laser beam emitted by the first laser device 101 and configured to reflect the blue laser beam and transmit the green laser beam. The sixth lens 126 and the seventh lens 127 are located on laser-exit paths of the red laser beam emitted by the first laser device 101 and configured to reflect the red laser beam.

The second laser device 102 emits the red laser beam to the eighth lens 134, the green laser beam emitted by the first laser device 101 is reflected by the fourth lens 124 and then transmitted to the eighth lens 134 by the fifth lens 125, and the blue laser beam emitted by the first laser device 101 is reflected by the fifth lens 125 to the eighth lens 134. The eighth lens 134 is located on a laser-exit path of the red laser beam emitted by the second laser device 102 and configured to reflect the red laser beam emitted by the second laser device 102 and transmit the green laser beam and the blue laser beam emitted by the second combining component 120.

In some embodiments, the fourth lens 124 may be a mirror for reflecting laser beams of all colors or a dichroic mirror for reflecting the green laser beam and transmitting laser beams of other colors. The fifth lens 125 may be a dichroic mirror for reflecting the blue laser beam and transmitting laser beams of other colors. The sixth lens 126 and the seventh lens 127 may be mirrors for reflecting laser beams of all colors or dichroic mirrors for reflecting the red laser beam and transmitting laser beams of other colors. The eighth lens 134 may be a dichroic mirror for reflecting the red laser beam and transmitting laser beams of other colors.

In the laser source assembly 100 provided in some embodiments of the present disclosure, the first laser device 101 and the second laser device 102 are laser devices emitting laser beams of three colors. Compared with the laser source assemblies using laser beams of one color (e.g., the blue laser beams) and fluorescent beams in the related art, there is no need for the laser source assembly 100 provided in some embodiments of the present disclosure to be provided with a wavelength conversion device, such as the phosphor wheel, so that the number of optical components in the laser source assembly 100 may be reduced and the volume of the laser source assembly 100 may be reduced.

Moreover, the volume of the laser source assembly 100 may be further reduced by providing the first laser device 101 and the second laser device 102 that are perpendicular to each other and using one combining component to combine the laser beams. In addition, the volume of the laser projection apparatus 10 may be effectively reduced after the laser source assembly 100 is integrated into the laser projection apparatus 10.

In some embodiments, as shown in FIG. 9A, the laser source assembly 100 further includes a converging lens 108 located on a laser-exit side of the first combining component 110 and configured to converge the first laser beam and the second laser beam. The light pipe 210 is located on a side of the converging lens 108 away from the first combining component 110 and configured to homogenize the first laser beam and the second laser beam.

In some other embodiments, as shown in FIGS. 9B to 9D, the laser beam combined by the combining lens group 103 is incident on the fly-eye lens 104. The fly-eye lens 104 is configured to homogenize the received laser beam.

For example, as shown in FIG. 9B, the fly-eye lens 104 is located on a side of the first combining component 110 away from the second laser device 102. An arrangement direction of the fly-eye lens 104 and the first combining component 110 is perpendicular to an arrangement direction of the first combining component 110 and the first laser device 101. Alternatively, as shown in FIGS. 9C and 9D, the fly-eye lens 104 is located on a side of the third combining component 130 away from the second combining component 120. An arrangement direction of the fly-eye lens 104 and the third combining component 130 is perpendicular to an arrangement direction of the third combining component 130 and the second laser device 102.

In a case where the laser source assembly 100 includes the fly-eye lens 104, as shown in FIGS. 9B to 9D, the lens group 220 is located on a side of the fly-eye lens 104 away from the combining lens assembly 103, and the prism group 250 and the light modulation device 240 are each located on a side of the lens group 220 away from the fly eye lens 104.

In some embodiments, as shown in FIG. 11, a center point E of a laser-exit surface of the fly-eye lens 104 coincides with a focus F of the lens group 220. For example, the center point E of the laser-exit surface of the fly-eye lens 104 coincides with the focus F of the lens group 220 proximate to the combining lens group 103. In this way, when the laser beam exiting from each point of the laser-exit surface of the fly-eye lens 104 is guided to the light modulation device 240, the laser beam may be incident on a surface of the light modulation device 240 as parallel light.

In the laser projection apparatus 10 provided in some embodiments of the present disclosure, since a volume of the fly-eye lens 104 is small, the volume of the laser source assembly 100 may be further effectively reduced by using the fly-eye lens 104 instead of the light pipe 210 to homogenize the laser beams. Moreover, there is no need to provide a beam contraction lens group and the converging lens 108 in the laser source assembly 100, which reduces the volume of the laser source assembly 100 and facilitates the miniaturization of the laser projection apparatus 10.

A speckle effect may be easily formed during projection imaging due to strong coherence of the laser beam. The speckle effect refers to an effect in which two laser beams emitted by a coherent laser source interfere with each other in space after they scatter by irradiating a rough object (e.g., the projection screen 20), and finally granular bright and dark spots appear on the screen. The speckle effect makes the display effect of the projection image poor, and these bright and dark unfocused spots appear as a flickering to the human eyes, which is prone to the feeling of dizziness when he or she keeps watching for a long time, and affect the usage effect of the laser projection apparatus 10.

According to the principle of eliminating coherence of the laser beam or eliminating speckle, in a case where the energy distribution of the laser beam is uniform, the energy distribution of the laser beam changes from a Gaussian curve to a substantially smooth straight line, and the speckle effect may be greatly reduced or eliminated. Therefore, in some embodiments, a diffusion plate may be disposed in the laser source assembly 100, so as to increase a divergence angle of the laser beam to improve the uniformity of the energy distribution of the laser beam, thereby reducing the speckle effect.

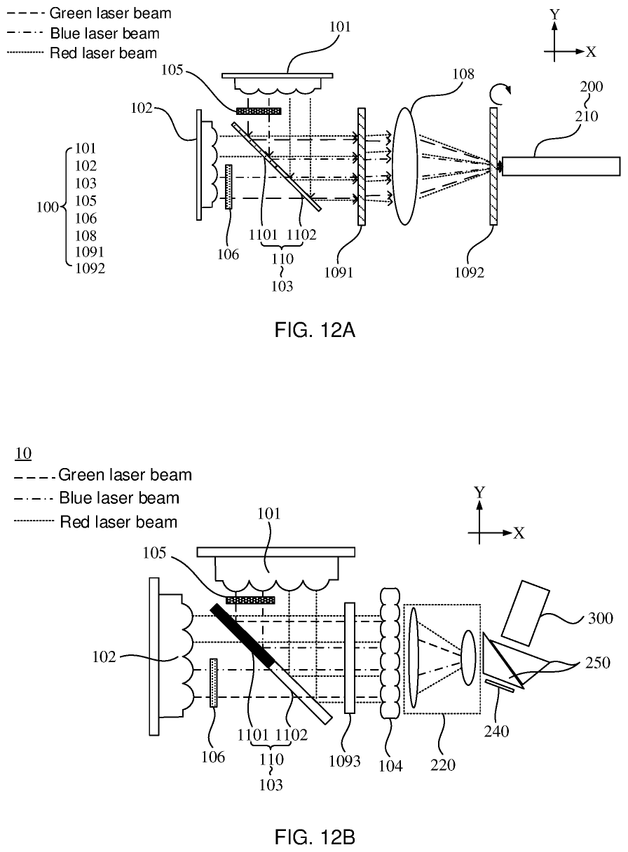

In some embodiments, as shown in FIG. 12A, the laser source assembly 100 further includes a first diffusion plate 1091 and a second diffusion plate 1092. The first diffusion plate 1091 is disposed between the first combining component 110 and the converging lens 108, and the second diffusion plate 1092 is disposed on the side of the converging lens 108 away from the first combining component 110. For example, the second diffusion plate 1092 is closer to the light pipe 210 than the first diffusion plate 1091.

The first diffusion plate 1091 may be fixedly disposed and configured to initially homogenize the combined beam spot. The second diffusion plate 1092 may be movable and configured to diffuse the converged laser beam, so as to increase the divergence angle and homogenizing the beam spot. In this way, by using a combination of dynamic and static diffusion plates, the number of random phases in the laser beam may be effectively increased, so as to interfere with the coherence of the laser beam, thereby increasing the randomness of speckles and reducing the graininess of speckles in the human eyes.

Of course, in some embodiments, the first diffusion plate 1091 may also be movable, and the second diffusion plate 1092 may also be fixedly disposed. Alternatively, both the first diffusion plate 1091 and the second diffusion plate 1092 may be movable. Alternatively, the laser source assembly 100 may also include a movable second diffusion plate 1092. It will be noted that the movement of the second diffusion plate 1092 or the first diffusion plate 1091 may be a rotational movement or a linear movement on a two-dimensional plane, and the present disclosure is not limited thereto.

In some embodiments, as shown in FIG. 12B, the laser source assembly 100 further includes a third diffusion plate 1093 located between the combining lens group 103 and the fly-eye lens 104 and configured to homogenize the incident laser beam.

The laser beam exiting from the combining lens group 103 is incident on the third diffusion plate 1093 in the first direction X. The third diffusion plate 1093 homogenizes the incident laser beam for a first time and then propagates the laser beam to the fly-eye lens 104. The fly-eye lens 104 homogenizes the incident laser beam for a second time. The third diffusion plate 1093 may be fixed, rotated, or moved on a two-dimensional plane. Of course, in some embodiments, the laser source assembly 100 may further include a fourth diffusion plate located on the side of the fly-eye lens 104 away from the combining lens group 103. For example, the fourth diffusion plate is fixed or rotatable.

The laser beam is linearly polarized light. According to different luminescence principles, the laser beam may be divided into P linearly polarized light and S linearly polarized light, which may be referred to as P-polarized light and S-polarized light, respectively. Polarization directions of the P-polarized light and the S-polarized light are perpendicular to each other. In a case where the laser projection apparatus 10 is used with an ultra-short-focus optical screen, the optical screen is composed of multi-layer microstructures and has different transmissivity or reflectivity for light with different polarization directions. For example, transmissivity of a Fresnel optical screen to the P-polarized light is greater than transmissivity of the Fresnel optical screen to the S-polarized light, so that the optical screen shows selectivity to the P-polarized light. The P-polarized light may be visible light in any wavelength range. Therefore, in some embodiments, polarized light with different polarization directions in the laser source assembly 100 may be changed into polarized light with a same polarization direction, thereby improving the luminance of the projection image.

The following is described by considering an example in which the blue laser beam and the green laser beam are the first polarized light, the red laser beam is the second polarized light, and the polarization direction of the first polarized light is perpendicular to the polarization direction of the second polarized light.

In some embodiments, the laser source assembly 100 further includes at least one polarization conversion component. The polarization conversion component is located between at least one laser device (e.g., the first laser device 101 and the second laser device 102) and the combining lens group 103 and configured to change a polarization direction of at least a portion of the laser beam of at least one color in the laser beams of three colors emitted by the at least one laser device.

For example, the polarization conversion component is configured to convert all red laser beams emitted by the at least one laser device from the second polarized light to the first polarized light. Alternatively, the polarization conversion component is configured to convert all green laser beams and blue laser beams emitted by the at least one laser device from the first polarized light to the second polarized light. Alternatively, the polarization conversion component is configured to convert a portion of the red laser beams emitted by the at least one laser device from the second polarized light to the first polarized light. Alternatively, the polarization conversion component is configured to change the polarization direction of a portion of the red laser beams, the polarization direction of a portion of the blue laser beam, and the polarization direction of a portion of the green laser beam emitted by the at least one laser device, so that the laser beam of each color may have two polarization directions.

In some embodiments, as shown in FIGS. 90, 12A, and 13, the at least one polarization conversion component includes a first polarization conversion component 105 and a second polarization conversion component 106. The first polarization conversion component 105 is configured to convert the green laser beam and the blue laser beam emitted by the first laser device 101 from the first polarized light into the second polarized light. The second polarization conversion component 106 is configured to convert the green laser beam and the blue laser beam emitted by the second laser device 102 from the first polarized light into the second polarized light.

In this case, the polarization directions of the blue laser beam and the green laser beam incident on the fly-eye lens 104 may be the same as the polarization direction of the red laser beam. In this way, the laser beams with a same polarization direction are used for forming the projection image, which may avoid a problem of color blocks in the formed projection image due to different transmissivity and reflectivity of the optical lenses for different polarized light.

In some embodiments, the first polarization conversion component 105 and the second polarization conversion component 106 each may be a half-wave plate.

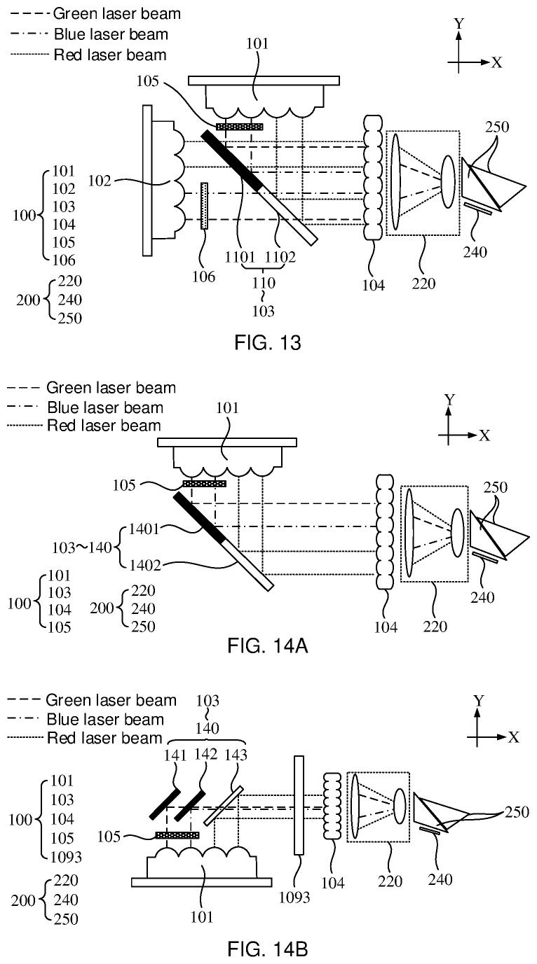

In some embodiments, as shown in FIGS. 12A, 12B, and 13, the first polarization conversion component 105 is located between the first laser device 101 and the first transflective portion 1101 of the first combining component 110, and the second polarization conversion component 106 is located between the second laser device 102 and the second transflective portion 1102 of the first combining component 110. Alternatively, as shown in FIG. 9C, the first polarization conversion component 105 is located between the first laser device 101 and the first lens 121 and second lens 122 of the second combining component 120, and the second polarization conversion component 106 is located between the second laser device 102 and the first lens 131 and second lens 132 of the third combining component 130.

It may be understood that the first polarization conversion component 105 and the second polarization conversion component 106 are suitable for the case where the first combining component 110 combines light by means of the wavelength selective characteristics thereof.

Of course, in some embodiments, the laser source assembly 100 may only include the first polarization conversion component 105. For example, as shown in FIG. 9D, the first polarization conversion component 105 is located between the first laser device 101 and the fourth lens 124 and fifth lens 125. In this case, the second polarization conversion component 106 may be omitted.

The above description is mainly given by considering an example in which the laser source assembly 100 includes two laser devices. However, in some other embodiments, the laser source assembly 100 may further include a single laser device. Referring to FIG. 14A, the laser source assembly 100 includes a first laser device 101, a combining lens group 103, and a fly-eye lens 104. The combining lens group 103 includes a fourth combining component 140 located on the laser-exit side of the first laser device 101, and an arrangement direction of the first laser device 101 and the fourth combining component 140 is perpendicular to an arrangement direction of the fourth combining component 140 and the fly eye lens 104.

The first laser device 101 emits the first laser beam to the fourth combining component 140, and the fourth combining component 140 reflects the first laser beam to the fly-eye lens 104. The fly-eye lens 104 homogenizes the received laser beam.

The fourth combining component 140 may have a variety of structures. In some embodiments of the present disclosure, a structure of the fourth combining component 140 will be described below by considering an example in which the first laser beam includes laser beams of three colors, such as the blue laser beam, the green laser beam, and the red laser beam.

In some embodiments, as shown in FIG. 14A, the fourth combining component 140 includes a first reflecting portion 1401 and a second reflecting portion 1402. On the plane where the laser-incident surface of the fly-eye lens 104 is located, an orthogonal projection of the first reflecting portion 1401 is separated from an orthogonal projection of the second reflecting portion 1402.

The first reflecting portion 1401 is located on laser-exit paths of the blue laser beam and the green laser beam emitted by the first laser device 101 and configured to reflect the blue laser beam and the green laser beam to the fly-eye lens 104. The second reflecting portion 1402 is located on a laser-exit path of the red laser beam emitted by the first laser device 101 and configured to reflect the red laser beam to the fly-eye lens 104.

In some embodiments, the first reflecting portion 1401 may be a mirror for reflecting laser beams of all colors or may be a dichroic mirror for reflecting the green laser beam and the blue laser beam and transmitting laser beams of other colors. The second reflecting portion 1402 may be a mirror for reflecting laser beams of all colors or may be a dichroic mirror for reflecting the red laser beam and transmitting laser beams of other colors. It may be understood that in a case where the first reflecting portion 1401 and the second reflecting portion 1402 of the fourth combining component 140 are both dichroic mirrors, the fourth combining component 140 may have the same structure as that of the first combining component 110.

In some other embodiments, referring to FIG. 14B, the fourth combining component 140 includes a first lens 141, a second lens 142, and a third lens 143 that are disposed separately. Structure and function of the fourth combining component 140 are similar to that of the second combining component 120 and the third combining component 130, and details will not be repeated herein. Here, since the structure and function of the fourth combining component 140 is similar to that of the second combining component 120 and the third combining component 130, the lenses of the fourth combining component 140, the second combining component 120, and the third combining component 130 share a same name and are distinguished by different reference signs.

It may be understood that, in a case where the laser source assembly 100 includes one laser device, as shown in FIGS. 14A and 14B, the laser source assembly 100 only includes the first polarization conversion component 105. As shown in FIG. 14A, the first polarization conversion component 105 is located between the first laser device 101 and the first reflecting portion 1401 of the fourth combining component 140. Alternatively, as shown in FIG. 14B, the first polarization conversion component 105 is located between the first laser device 101 and the first lens 141 and second lens 142 of the fourth combining component 140. For the relevant content of the first polarization conversion component 105, reference may be made to the relevant content described above, and details will not be repeated herein.

The structure of the fly-eye lens 104 in some embodiments of the present disclosure will be described in detail below.

In some embodiments, as shown in FIG. 15, the fly-eye lens 104 includes a base 1042, a plurality of first microlenses 1041, and a plurality of second microlenses 1043. The base 1042 may be made of glass. The plurality of first microlenses 1041 are disposed on a laser-incident surface 1042A of the base 1042 and arranged in an array. The plurality of second microlenses 1043 are disposed on a laser-exit surface 1042B of the base 1042 and arranged in an array. The plurality of first microlenses 1041 correspond to the plurality of second microlenses 1043, for example, in a one-to-one manner, and a shape and a size of each first microlens 1041 are the same as that of the corresponding second microlens 1043. For example, the plurality of first microlenses 1041 and the plurality of second microlenses 1043 may be spherical convex lenses or aspherical convex lenses.

In this way, the plurality of first microlenses 1041 may divide the beam spot of the laser beams emitted by one or more laser devices, and then superimpose the divided beam spots by using the plurality of second microlenses 1043, so as to homogenize the laser beams emitted by the laser device.

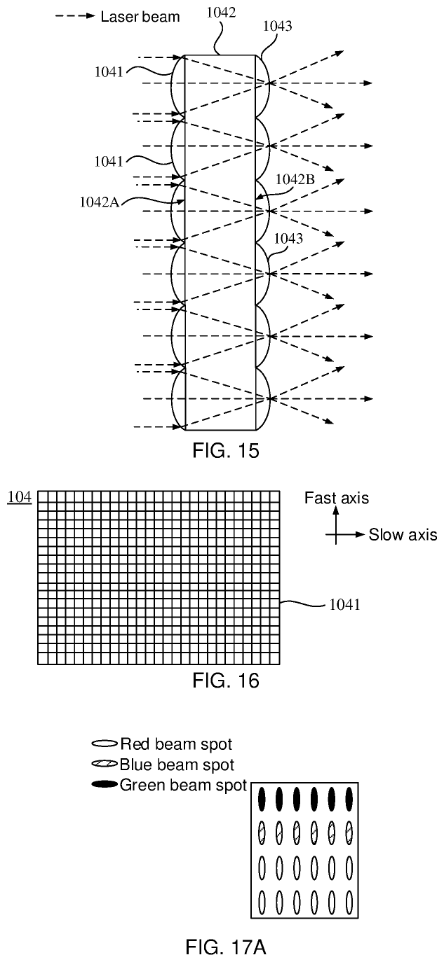

In some embodiments, as shown in FIG. 16, in a target direction (i.e., at least one of a fast axis direction or a slow axis direction of a laser beam), a dimension (e.g., a length or a width) of the first microlens 1041 is related to a dimension (e.g., a length or a width) of a beam spot formed by the laser beam emitted by at least one of the light-emitting chips 1001 on the laser-incident surface of the fly-eye lens 104 and a corresponding dimension (e.g., a length or a width) of the light modulation device (e.g., the digital micromirror device) 240. That is to say, the dimension of the first microlens 1041 may be determined according to the dimension of the beam spot of the laser beam emitted by the laser device and the dimension of the light modulation device 240, so as to improve the homogenizing effect of the fly-eye lens 104 on the laser beam emitted by the laser device.

For example, the dimension of the first microlens 1041 or the second microlens 1043 in the target direction is related to a corresponding dimension of the light modulation device 240 in the target direction, an imaging angle (e.g., the field of view, FOV) of the projection lens 300, and a corresponding dimension of the beam spot formed by the laser beam emitted by at least one of the light-emitting chips 1001 on the laser-incident surface of the fly-eye lens 104 in the target direction. After the model of the light modulation device 240, the model of the projection lens 300, and the model of the light-emitting chip 1001 are determined, the corresponding dimension of the light modulation device 240 in the target direction, the imaging angle of the projection lens 300, and the corresponding dimension of the beam spot formed by the laser beam emitted by at least one of the light-emitting chips 1001 on the laser-incident surface of the fly-eye lens 104 in the target direction are constant values, so that the dimension of the first microlens 1041 or the second microlens 1043 in the target direction may be determined.

It will be noted that the first laser device 101 and the second laser device 102 may be semiconductor laser devices, and the laser beam emitted by the semiconductor laser device has a fast axis and a slow axis. A divergence angle of the laser beam in the fast axis direction is within a range of about minus 30° to plus 30° (i.e., ±30°) inclusive, and a divergence angle of the laser beam in the slow axis direction is within a range of about minus 10° to plus 10° (i.e., ±10°) inclusive. Therefore, a dimension of the beam spot in the fast axis direction is greater than a dimension of the beam spot in the slow axis direction, and the beam spot may be in a shape of a rectangle or an ellipse after the laser beams emitted by the first laser device 101 and the second laser device 102 are collimated. In this case, a direction of a long side of the beam spot is the fast axis direction, and a direction of a short side of the beam spot is the slow axis direction.

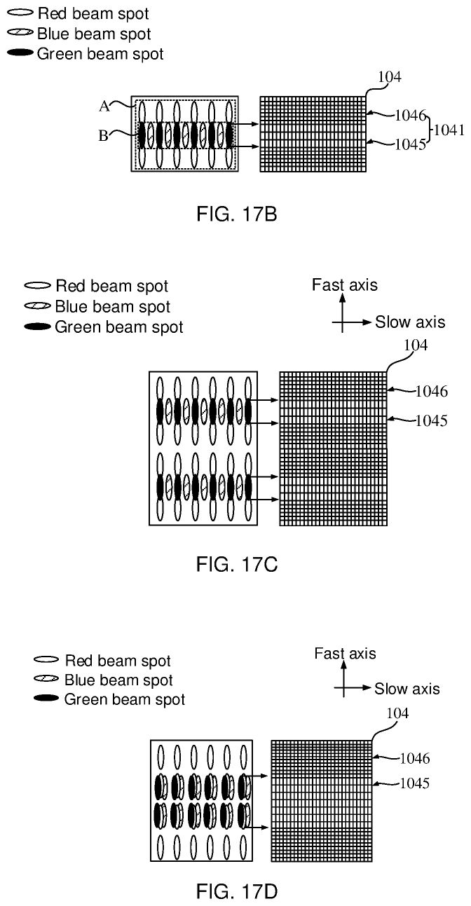

FIG. 17A is a schematic diagram of beam spots formed by the laser devices shown in FIGS. 9A and 9B. As shown in FIG. 17A, the beam spot formed by the laser beam emitted by at least one of the plurality of light-emitting chips 1001 on the laser-incident surface of the fly-eye lens 104 overlaps at least one first microlens 1041. In this case, the laser beams emitted by the laser devices may be homogenized by the fly-eye lens 104.

In some embodiments, the beam spot formed by the laser beam emitted by at least one light-emitting chip 1001 on the laser-incident surface of the fly-eye lens 104 overlaps at least two first microlenses 1041. In this way, it is possible to improve the homogenizing effect of the fly-eye lens 104 on the laser beams emitted by the laser devices.

In some embodiments, the beam spot formed by the laser beam emitted by at least one light-emitting chip 1001 on the laser-incident surface of the fly-eye lens 104 overlaps at least four first microlenses 1041, and the at least four first microlenses 1041 are arranged in at least two rows and two columns.

For example, in a case where the beam spot formed by the laser beam emitted by each light-emitting chip 1001 on the laser-incident surface of the fly-eye lens 104 overlaps a region where four first microlenses 1041 are located, the four first microlenses 1041 may be arranged in two rows and two columns. In this way, it is possible to further improve the homogenizing effect of the fly-eye lens 104 on the laser beams emitted by the laser devices.

In some embodiments, the plurality of first microlenses 1041 may have a same size. For example, the dimensions of the first microlens 1041 in the fast axis direction and the slow axis direction are each within a range of 0.1 mm to 1 mm, inclusive.

Of course, in some other embodiments, the plurality of first microlenses 1041 may also have different sizes, and the present disclosure is not limited thereto.

In the laser device, the number of red light-emitting chips is usually greater than the numbers of the blue light-emitting chips and the green light-emitting chips, so as to improve the imaging quality of the projection image of the laser projection apparatus 10. For example, the first laser device 101 and the second laser device 102 each include two rows of red light-emitting chips, one row of blue light-emitting chips, and one row of green light-emitting chips. The size of the beam spot formed by the red laser beam is greater than the size of the beam spot formed by the blue laser beam and the green laser beam after the laser beams of three colors are combined by the combining lens group 103.

For example, as shown in FIG. 17B, an area of the beam spot formed by the red laser beam on the laser-incident surface of the fly-eye lens 104 is a first area A, and an area of the beam spot formed by the blue laser beam and the green laser beam on the laser-incident surface of the fly-eye lens 104 is a second area B, and the second area B is less than the first area A. That is to say, the area of the beam spot formed by the blue laser beam and the green laser beam on the laser-incident surface of the fly-eye lens 104 is less than the area of the beam spot formed by the red laser beam on the laser-incident surface of the fly-eye lens 104.

Here, the area of the beam spot formed by the blue laser beam and the green laser beam on the laser-incident surface of the fly-eye lens 104 may be construed as a total area occupied by the beam spots corresponding to the blue laser beam and the green laser beam on the laser-incident surface of the fly-eye lens 104. It may be construed that an area of a beam spot of the blue laser beam or the green laser beam on the laser-incident surface of the fly-eye lens 104 is also less than the area of the beam spot formed by the red laser beam on the laser-incident surface of the fly-eye lens 104.

Since Etendue of a laser beam is a product of an area of a beam spot of the laser beam and a divergence angle of the laser beam, and the area of the beam spot is proportional to the divergence angle, in a case where optical paths of laser beams of different colors are substantially same, the Etendue of the red laser beam is greater than any of the Etendue of the blue laser beam and the Etendue of the green laser beam, which results in a color boundary phenomenon in the beam spot formed after the laser beams of three colors are combined. For example, an edge region of the combined beam spot is redder than a middle region of the combined beam spot. When the combined beam spot is incident on the projection lens 300 in the laser projection apparatus 10 to form the projection image, the color uniformity of the projection image is poor, resulting in a poor display effect of the laser projection apparatus 10.

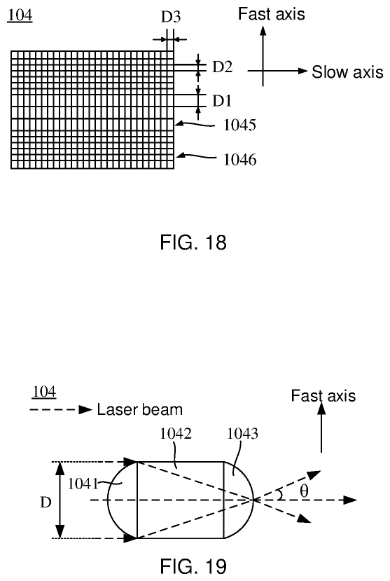

To this end, in some embodiments, as shown in FIGS. 17B to 17D and FIG. 18, the plurality of first microlenses 1041 include a plurality of first sub-microlenses 1045 and a plurality of second sub-microlenses 1046. The plurality of first sub-microlenses 1045 are substantially located within a region of the fly-eye lens 104 irradiated by the blue laser beam and the green laser beam and configured to receive the blue laser beam, the green laser beam, and a first portion of the red laser beam. The plurality of second sub-microlenses 1046 are substantially located within a region of the fly-eye lens 104 irradiated by the red laser beam and configured to receive a second portion of the red laser beam. A dimension of the first sub-microlens 1045 in the fast axis direction is greater than a dimension of the second sub-microlens 1046 in the fast axis direction. Here, the red laser beam includes the first portion and the second portion.

It will be noted that FIG. 17B is a schematic diagram of beam spots formed by the laser device shown in FIG. 14B on the fly-eye lens 104. FIG. 17C is a schematic diagram of beam spots formed by the laser devices shown in FIG. 9C on the fly-eye lens 104. FIG. 17D is a schematic diagram of beam spots formed by the laser devices shown in FIG. 9D on the fly-eye lens 104.

FIG. 19 illustrates one first microlens 1041 disposed on the laser-incident surface of fly-eye lens 104 and one second microlens 1043 correspondingly disposed on the laser-exit surface of fly-eye lens 104. For example, as shown in FIG. 19, the first microlens 1041 converges light (e.g., the laser beam) to a center point of the second microlens 1043. In this way, the light exiting from the second microlens 1043 may propagate at a divergence angle θ. Moreover, the larger the dimension D of the first microlens 1041 and the second microlens 1043 in the fast axis direction, the larger the divergence angle θ of the light exiting from the second microlens 1043.

Among the plurality of first microlenses 1041, the dimensions of the plurality of first sub-microlenses 1045 receiving the blue laser beam and the green laser beam in the fast axis direction are greater than that of the plurality of second sub-microlenses 1046 receiving the red laser beam in the fast axis direction. Therefore, after the blue laser beam and the green laser beam are incident on the plurality of first sub-microlenses 1045, the increase in the divergence angle of the blue laser beam and the green laser beam is greater than that of the red laser beam, so that Etendue of the blue laser beam and Etendue of the green laser beam may increase compared to Etendue of the red laser beam.

In this way, Etendue of the blue laser beam and Etendue of the green laser beam may be approximately the same as the Etendue of the red laser beam, thereby avoiding the color boundary phenomenon in the beam spot formed after the laser beams of the three colors are combined. Therefore, when the combined beam spot is incident on the projection lens 300 to form the projection image, the color uniformity of the projection image is high, thereby improving the display effect of the laser projection apparatus 10.

In some embodiments, as shown in FIGS. 17B to 18, a dimension D1 of the first sub-microlens 1045 in the fast axis direction is greater than a dimension D2 of the second sub-microlens 1046 in the fast axis direction, and a dimension of the first sub-microlens 1045 in the slow axis direction may be equal to a dimension of the second sub-microlens 1046 in the slow axis direction, for example, both of which are equal to a dimension D3.

In some embodiments, a first ratio of the area of the beam spot formed by the red laser beam on the laser-incident surface of the fly-eye lens 104 to the area of the beam spot formed by the blue laser beam and the green laser beam on the laser-incident surface of the fly-eye lens 104 is proportional to a second ratio of the dimension of the first sub-microlens 1045 in the fast axis direction to the dimension of the second sub-microlens 1046 in the fast axis direction.

For example, as the first ratio of the area of the beam spot formed by the red laser beam on the laser-incident surface of the fly-eye lens 104 to the area of the beam spot formed by the blue laser beam and the green laser beam on the laser-incident surface of the fly-eye lens 104 increases or decreases, the second ratio of the dimension of the first sub-microlens 1045 in the fast axis direction to the dimension of the second sub-microlens 1046 in the fast axis direction also increases or decreases.

In the laser source assembly 100 provided in some embodiments of the present disclosure, the dimension of any one of the plurality of first sub-microlenses 1045 in the fast axis direction is greater than the dimension of any one of the plurality of second sub-microlenses 1046 in the fast axis direction, so as to increase Etendue of the blue laser beam and Etendue of the green laser beam. In this way, the laser beams become uniform due to the action of the fly-eye lens 104, so that the interference generated by these laser beams when used for projection may be weak, which may reduce the speckle effect when the laser projection apparatus 10 performs projection display, and avoid the fuzzy projection image, improve the display effect of projection image, and avoid the feeling of dizziness when viewed by the human eyes.

In the above description of the embodiments, specific features, structures, materials, or characteristics may be combined in a suitable manner in any one or more embodiments or examples.

A person skilled in the art will understand that the scope of disclosure in the present disclosure is not limited to specific embodiments discussed above and may modify and substitute some elements of the embodiments without departing from the spirits of the present disclosure. The scope of the present disclosure is limited by the appended claims.

What is claimed is:

1. A laser projection apparatus, comprising:
a laser source assembly configured to provide illumination beams;
a light modulation assembly configured to modulate the illumination beams provided by the laser source assembly, so as to obtain projection beams; and
a projection lens configured to project the projection beams into an image;
wherein the laser source assembly includes:
at least one laser device configured to emit laser beams of three colors, the laser beams of three colors including a blue laser beam, a green laser beam, and a red laser beam;
a combining lens group located on a laser-exit side of the at least one laser device and configured to combine the laser beams emitted by the at least one laser device; and
a fly-eye lens located on a laser-exit side of the combining lens group and configured to homogenize the laser beams emitted by the at least one laser device, the fly-eye lens including:
a base;
a plurality of first microlenses disposed on a laser-incident surface of the base, and the plurality of first microlenses including:
a plurality of first sub-microlenses configured to receive the blue laser beam, the green laser beam, and a first portion of the red laser beam; and
a plurality of second sub-microlenses configured to receive a second portion of the red laser beam; and
a plurality of second microlenses disposed on a laser-exit surface of the base and respectively corresponding to the plurality of first microlenses;
wherein an area of a beam spot produced by the blue laser beam and the green laser beam on a laser-incident surface of the fly-eye lens is less than an area of a beam spot produced by the red laser beam on the laser-incident surface of the fly-eye lens; and a dimension of the first sub-microlens in a fast axis direction of the incident laser beam is greater than a dimension of the second sub-microlens in the fast axis direction.

2. The laser projection apparatus according to claim 1, wherein each of the at least one laser device includes a plurality of light-emitting chips configured to emit the laser beams; and the light modulation assembly includes a light modulation device configured to modulate the illumination beams, so as to obtain the projection beams; and
in a target direction, a dimension of the first microlens is related to a dimension of a beam spot produced by the laser beam emitted by at least one of the plurality of light-emitting chips on the laser-incident surface of the fly-eye lens, a corresponding dimension of the light modulation device, and an imaging angle of the projection lens; wherein the target direction includes at least one of the fast axis direction or a slow axis direction of the laser beam.

3. The laser projection apparatus according to claim 1, wherein a first ratio of the area of the beam spot produced by the red laser beam on the laser-incident surface of the fly-eye lens to the area of the beam spot produced by the blue laser beam and the green laser beam on the laser-incident surface of the fly-eye lens is proportional to a second ratio of the dimension of the first sub-microlens in the fast axis direction to the dimension of the second sub-microlens in the fast axis direction.

4. The laser projection apparatus according to claim 1, wherein each of the at least one laser device includes a plurality of light-emitting chips, and the fly-eye lens satisfies at least one of following:
the beam spot produced by the laser beam emitted by at least one of the plurality of light-emitting chips on the laser-incident surface of the fly-eye lens overlaps at least one of the plurality of first microlenses;
the beam spot produced by the laser beam emitted by at least one of the plurality of light-emitting chips on the laser-incident surface of the fly-eye lens overlaps at least two of the plurality of first microlenses; or
the beam spot produced by the laser beam emitted by at least one of the plurality of light-emitting chips on the laser-incident surface of the fly-eye lens overlaps at least four of the plurality of first microlenses, and the at least four first microlenses are arranged in at least two rows and two columns.

5. The laser projection apparatus according to claim 1, wherein
the least one laser device includes:
a first laser device configured to emit a first laser beam; and
a second laser device configured to emit a second laser beam; the first laser beam and the second laser beam each including the blue laser beam, the green laser beam, and the red laser beam;
the combining lens group includes a first combining component, and the first combining component is located on laser-exit sides of the first laser device and the second laser device and configured to reflect the first laser beam and transmit the second laser beam; an arrangement direction of the first laser device and the first combining component is perpendicular to an arrangement direction of the second laser device and the first combining component; and the first combining component includes:
a first transflective portion disposed obliquely with respect to a laser-exit direction of at least one of the first laser device or the second laser device and configured to reflect the blue laser beam and the green laser beam in the first laser beam and transmit the red laser beam in the second laser beam; and
a second transflective portion disposed obliquely with respect to the laser-exit direction of at least one of the first laser device or the second laser device and configured to reflect the red laser beam in the first laser beam and transmit the blue laser beam and the green laser beam in the second laser beam.

6. The laser projection apparatus according to claim 5, wherein the first combining component satisfies one of following:
the first transflective portion and the second transflective portion are two dichroic elements with different wavelength selection characteristics; and
the first transflective portion and the second transflective portion are two polarizing elements with different polarization direction selection characteristics.

7. The laser projection apparatus according to claim 1, wherein the laser source assembly further includes at least one polarization conversion component, and the at least one polarization conversion component is located between the at least one laser device and the combining lens group and configured to change a polarization direction of at least a portion of the laser beam of at least one color in the laser beams of three colors.

8. The laser projection apparatus according to claim 7, wherein the blue laser beam and the green laser beam are a first polarized light, the red laser beam is a second polarized light, and a polarization direction of the first polarized light is perpendicular to a polarization direction of the second polarized light; and the at least one polarization conversion component includes:
a first polarization conversion component configured to convert the green laser beam and the blue laser beam emitted by the at least one laser device from the first polarized light into the second polarized light; and
a second polarization conversion component configured to convert the green laser beam and the blue laser beam emitted by the at least one laser device from the first polarized light into the second polarized light.

9. The laser projection apparatus according to claim 1, wherein
the at least one laser device includes:
a first laser device configured to emit a first laser beam; and
a second laser device configured to emit a second laser beam; the first laser beam and the second laser beam each including the blue laser beam, the red laser beam, and the green laser beam;
the combining lens group includes:
a second combining component located on a laser-exit side of the first laser device and configured to reflect the first laser beam; and
a third combining component located on a laser-exit side of the second laser device and configured to reflect the second laser beam; an arrangement direction of the first laser device and the second combining component being parallel to an arrangement direction of the second laser device and the third combining component;
the second combining component and the third combining component each include:
a first lens configured to reflect the green laser beam;
a second lens configured to reflect the blue laser beam and transmit the green laser beam; and
a third lens configured to reflect the red laser beam and transmit the green laser beam and the blue laser beam;
wherein the first lens, the second lens, and the third lens are sequentially arranged in a first direction, and each are disposed obliquely with respect to the first direction, on a plane where the laser-incident surface of the fly-eye lens is located, an orthogonal projection of the first lens, an orthogonal projection of the second lens, and an orthogonal projection of the third lens at least partially overlap with each other.

10. The laser projection apparatus according to claim 1, wherein
the at least one laser device includes:
a first laser device configured to emit a first laser beam, the first laser beam including the blue laser beam, the red laser beam, and the green laser beam; and
a second laser device configured to emit a second laser beam, the second laser beam including the red laser beam;
the combining lens group includes:
a second combining component located on a laser-exit side of the first laser device and configured to reflect the first laser beam; the second combining component including:
a fourth lens configured to reflect the green laser beam;
a fifth lens configured to reflect the blue laser beam and transmit the green laser beam, wherein on a plane where the laser-incident surface of the fly-eye lens is located, an orthogonal projection of the fourth lens at least partially overlaps with an orthogonal projection of the fifth lens; and
a sixth lens and a seventh lens that are configured to reflect the red laser beam, wherein on the plane where the laser-incident surface of the fly-eye lens is located, orthogonal projections of the sixth lens and the seventh lens are located on two sides of the orthogonal projection of the fifth lens in a second direction, respectively; and
a third combining component located on a laser-exit side of the second laser device and configured to reflect the second laser beam; an arrangement direction of the first laser device and the second combining component being parallel to an arrangement direction of the second laser device and the third combining component; and the third combining component including an eighth lens configured to reflect the red laser beam and transmit the green laser beam and the blue laser beam, wherein on the plane where the laser-incident surface of the fly-eye lens is located, an orthogonal projection of the eighth lens at least partially overlaps with the orthogonal projections of the fourth lens and the fifth lens and is separated from the orthogonal projections of the sixth lens and the seventh lens.

11. The laser projection apparatus according to claim 1, wherein
the at least one laser device includes a first laser device configured to emit a first laser beam; and the first laser beam includes the blue laser beam, the green laser beam, and the red laser beam;
the combining lens group includes a fourth combining component located on a laser-exit side of the first laser device and configured to reflect the first laser beam to the fly-eye lens; and the fourth combining component satisfies one of following:
the fourth combining component includes:
a first reflecting portion configured to reflect the blue laser beam and the green laser beam; and
a second reflecting portion configured to reflect the red laser beam;
and
the fourth combining component includes:
a first lens configured to reflect the green laser beam;
a second lens configured to reflect the blue laser beam and transmit the green laser beam; and
a third lens configured to reflect the red laser beam and transmit the green laser beam and the blue laser beam;
wherein the first lens, the second lens, and the third lens are sequentially arranged in a first direction and each are disposed obliquely with respect to the first direction, on a plane where the laser-incident surface of the fly-eye lens is located, an orthogonal projection of the first lens, an orthogonal projection of the second lens, and an orthogonal projection of the third lens at least partially overlap with each other.

12. A laser projection apparatus, comprising:
a laser source assembly configured to provide illumination beams, the laser source assembly including:
at least one laser device configured to emit laser beams of three colors, the laser beams of three colors including a blue laser beam, a green laser beam, and a red laser beam;
a combining lens group located on a laser-exit side of the at least one laser device and configured to combine the laser beams emitted by the at least one laser device;
a fly-eye lens located on a laser-exit side of the combining lens group and configured to homogenize the laser beams emitted by the at least one laser device; and
a diffusion plate located between the combining lens group and the fly-eye lens and configured to homogenize the incident laser beams;
a light modulation assembly configured to modulate the illumination beams provided by the laser source assembly, so as to obtain projection beams, the light modulation assembly including:
a lens group located on a laser-exit side of the fly-eye lens, a center point of a laser-exit surface of the fly-eye lens coinciding with a focus of the lens group, and the lens group being configured to first diffuse the illumination beams and then converge the illumination beams;
a prism group located on a laser-exit side of the lens group and configured to reflect the illumination beams to a light modulation device; and
the light modulation device configured to modulate the illumination beams, so as to obtain the projection beams; and
a projection lens configured to project the projection beams into an image.

13. The laser projection apparatus according to claim 12, wherein the fly-eye lens includes:
a base;
a plurality of first microlenses disposed on a laser-incident surface of the base, and the plurality of first microlenses including:
a plurality of first sub-microlenses configured to receive the blue laser beam, the green laser beam, and a first portion of the red laser beam; and
a plurality of second sub-microlenses configured to receive a second portion of the red laser beam; and
a plurality of second microlenses disposed on a laser-exit surface of the base and respectively corresponding to the plurality of first microlenses;
wherein an area of a beam spot produced by the blue laser beam and the green laser beam on a laser-incident surface of the fly-eye lens is less than an area of a beam spot produced by the red laser beam on the laser-incident surface of the fly-eye lens; and a dimension of the first sub-microlens in a fast axis direction of the incident laser beam is greater than a dimension of the second sub-microlens in the fast axis direction.

14. The laser projection apparatus according to claim 13, wherein each of the at least one laser device includes a plurality of light-emitting chips configured to emit the laser beams;
in a target direction, a dimension of the first microlens is related to a dimension of a beam spot produced by the laser beam emitted by at least one of the plurality of light-emitting chips on the laser-incident surface of the fly-eye lens, a corresponding dimension of the light modulation device, and an imaging angle of the projection lens; wherein the target direction includes at least one of the fast axis direction or a slow axis direction of the laser beam.

15. The laser projection apparatus according to claim 13, wherein a first ratio of the area of the beam spot produced by the red laser beam on the laser-incident surface of the fly-eye lens to the area of the beam spot produced by the blue laser beam and the green laser beam on the laser-incident surface of the fly-eye lens is proportional to a second ratio of the dimension of the first sub-microlens in the fast axis direction to the dimension of the second sub-microlens in the fast axis direction.

16. The laser projection apparatus according to claim 12, wherein
the least one laser device includes:
a first laser device configured to emit a first laser beam; and
a second laser device configured to emit a second laser beam; the first laser beam and the second laser beam each including the blue laser beam, the green laser beam, and the red laser beam;
the combining lens group includes a first combining component, the first combining component is located on laser-exit sides of the first laser device and the second laser device and configured to reflect the first laser beam and transmit the second laser beam; and an arrangement direction of the first laser device and the first combining component is perpendicular to an arrangement direction of the second laser device and the first combining component; the first combining component includes:
a first transflective portion disposed obliquely with respect to a laser-exit direction of at least one of the first laser device or the second laser device and configured to reflect the blue laser beam and the green laser beam in the first laser beam and transmit the red laser beam in the second laser beam; and
a second transflective portion disposed obliquely with respect to the laser-exit direction of at least one of the first laser device or the second laser device and configured to reflect the red laser beam in the first laser beam and transmit the blue laser beam and the green laser beam in the second laser beam.

17. The laser projection apparatus according to claim 12, wherein
the at least one laser device includes:
a first laser device configured to emit a first laser beam; and
a second laser device configured to emit a second laser beam; the first laser beam and the second laser beam each including the blue laser beam, the red laser beam, and the green laser beam;
the combining lens group includes:
a second combining component located on a laser-exit side of the first laser device and configured to reflect the first laser beam; and
a third combining component located on a laser-exit side of the second laser device and configured to reflect the second laser beam; an arrangement direction of the first laser device and the second combining component being parallel to an arrangement direction of the second laser device and the third combining component;
the second combining component and the third combining component each include:
a first lens configured to reflect the green laser beam;
a second lens configured to reflect the blue laser beam and transmit the green laser beam; and
a third lens configured to reflect the red laser beam and transmit the green laser beam and the blue laser beam;
wherein the first lens, the second lens, and the third lens are sequentially arranged in a first direction and each are disposed obliquely with respect to the first direction, on a plane where the laser-incident surface of the fly-eye lens is located, an orthogonal projection of the first lens, an orthogonal projection of the second lens, and an orthogonal projection of the third lens at least partially overlap with each other.

18. The laser projection apparatus according to claim 12, wherein
the at least one laser device includes:
a first laser device configured to emit a first laser beam, the first laser beam including the blue laser beam, the red laser beam, and the green laser beam; and
a second laser device configured to emit a second laser beam, the second laser beam including the red laser beam;
the combining lens group includes:
a second combining component located on a laser-exit side of the first laser device and configured to reflect the first laser beam; the second combining component including:
a fourth lens configured to reflect the green laser beam;
a fifth lens configured to reflect the blue laser beam and transmit the green laser beam, wherein on a plane where the laser-incident surface of the fly-eye lens is located, an orthogonal projection of the fourth lens at least partially overlaps with an orthogonal projection of the fifth lens; and
a sixth lens and a seventh lens that are configured to reflect the red laser beam, wherein on the plane where the laser-incident surface of the fly-eye lens is located, orthogonal projections of the sixth lens and the seventh lens are located on two sides of the orthogonal projection of the fifth lens in a second direction, respectively; and
a third combining component located on a laser-exit side of the second laser device and configured to reflect the second laser beam; an arrangement direction of the first laser device and the second combining component being parallel to an arrangement direction of the second laser device and the third combining component; and the third combining component including an eighth lens configured to reflect the red laser beam and transmit the green laser beam and the blue laser beam, wherein on the plane where the laser-incident surface of the fly-eye lens is located, an orthogonal projection of the eighth lens at least partially overlaps with the orthogonal projections of the fourth lens and the fifth lens and is separated from the orthogonal projections of the sixth lens and the seventh lens.

19. The laser projection apparatus according to claim 12, wherein the laser source assembly further includes at least one polarization conversion component, and the at least one polarization conversion component is located between the at least one laser device and the combining lens group and configured to change a polarization direction of at least a portion of the laser beam of at least one color in the laser beams of three colors.

20. The laser projection apparatus according to claim 12, wherein the diffusion plate satisfies one of following:
the diffusion plate is rotatably provided between the combining lens group and the fly-eye lens; and
the diffusion plate is movably provided between the combining lens group and the fly eye lens.
